(19) United States
(12) Patent Application Publication
(10) Pub. No.: US 2023/0235416 A1
(43) Pub. Date: Jul. 27, 2023

(54) LEATHER PROCESSING UTILIZING SUPER-CRITICAL OR NEAR SUPER-CRITICAL CO2 VALUE

(71) Applicant: FOLIUM BIOSCIENCES EUROPE B.V., WEESP (NL)

(72) Inventors: Daniela Oana TRAMBITAS, WEESP (NL); Brigitta BOHUS, WEESP (NL); Tjerk Jan DE VRIES, WEESP (NL); Geert Feye WOERLEE, WEESP (NL)

(73) Assignee: FOLIUM BIOSCIENCES EUROPE B.V., WEESP (NL)

(21) Appl. No.: 18/007,188

(22) PCT Filed: Jul. 29, 2021
(86) PCT No.: PCT/EP2021/071350

§ 371 Date: Jan. 27, 2023

(30) Foreign Application Priority Data
Jul. 29, 2020 (EP) 20188393.1

(51) Int. Cl. C14C 9/02; D06M 23/10; D06P 3/32; D06P 1/94

(52) U.S. Cl. CPC C14C 9/02; D06M 23/105; D06P 3/32; D06P 1/94

(57) ABSTRACT

A method for processing natural or synthetic leather by using super-critical CO₂. The leather can be dried leather, low grade leathers, thin leather, crust leathers, finished leathers, wet blue leathers, and tanned leather, as well as synthetic leather. In a second aspect the invention relates to leather obtained by said method, and in a third aspect to a stand-alone apparatus for performing said method.

### FIELD OF THE INVENTION

The present invention is in the field of a method for processing various types of leather by using super-critical or near-super-critical CO₂ value. The leather can be dried leather low grade leathers, thin leather, crust leathers, finished leathers, wet blue (WB) leathers, and tanned leather. In a second aspect the invention relates to leather obtained by said method, and in a third aspect to a stand-alone apparatus for performing said method.

### BACKGROUND OF THE INVENTION

Processing natural leather involves several steps typically based on old, intensive water-, chemicals- and time-consuming techniques which are used to transform hides into leather designated for making the final products. Among others, main steps involve: tanning, drying, re-tanning, fat-liquoring, dyeing and finishing. Leather processing is known to yield a lot of waste including water and additional chemical solvents and a lot of salts. Dyeing leather in particular is a tedious process for above mentioned reasons but also for additional high finishing processing like colour brightness, intensity and nuance.

In a first stage of obtaining leather a hide or skin is tanned. Tanning is a process of treating skins and hides of animals to produce leather. Tanning hide into leather involves a process which permanently alters the structure of the hide, making it more durable and less susceptible to decomposition, and also possibly pre-colouring it. Before tanning the hide is pre-treated, such as by dehairing, degreasing, desalting and soaking in water. The process is often rather environment unfriendly. Traditionally, tanning used tannin, an acidic chemical compound from which the tanning process draws its name. The use of a chromium (III) solution was adopted by tanners during the Industrial Revolution. As an alternative to the use of a chromium (III) solution other tanning materials and methods have been developed (e.g. vegetable tanning or aldehyde- wet white).

The conventional process is designed effectively for different grades of leather and depends directly on the initial quality of the hide. In addition for the leather industry, handling and processing lower grades leather for improving their properties towards their utilization for high quality leather products is a continuous challenge. This needs constant attention in special treatments of different parts of leather (especially the thin ones) for bringing them to similar quality products as the rest.

Many companies and specialized research institutes had tried, over the years, utilizing dense gases for implementing different dry processing steps in the leather industry. Some of them have succeeded in degreasing, washing and/or tanning hides, however a complete process cycle including de-hydration (drying), fat-liquoring, also referred to as softening, re-tanning, and dyeing have not yet been published.

US2005214464 (A1) recite a material to be processed into leather products such as leather and fur characterized in that at least one effective component of an aromatic component, a deodorant component, a drug effective component, an antibacterial component, an anti-mould component, and an insect-controlling component, or a fat or oil component such as a fat liquoring agent is impregnated into tissue and fibre of animal hide or skin using a high pressure fluid as a medium. JP 2006 057042 (A) recites a method for impregnation treatment that is capable of impregnating an impregnant having a molecular weight larger than a certain number deeply into the inside of the base material without adverse effect on the fabric hand. In an impregnation method for impregnating an impregnant into a base material in supercritical carbon dioxide, the peak molecular weight of the impregnant is 1,000 or more according to the GPC measurement and the supercritical carbon dioxide includes a co-solvent having a solubility of 100 g/100 ml water or less at 20° C. Prokein et al. in “Low-chromium and low-sulphate emission leather tanning intensified by compressed carbon dioxide”, Clean Technologies and Environmental Policy, Springer, Vol. 19, No. 10, p. 2455-2465 focus on the reduction of tanning agent consumed by the chromium tanning procedure. Compressed carbon dioxide is used to intensify the process. Carbon dioxide-intensified tanning at 60 bar allows the production of high-quality leather by using about 50 wt. % less of tanning agent compared to the conventional tanning process. The chromium and sulphate concentrations in the wastewater generated by the tanning process are highly reduced, but still present. Results of full skin tanning (bull skin; up to 10 square metre per skin) in a high-pressure reactor with a volume of 1700-L are presented for the first time.

The present invention therefore relates to a method for processing leather, leather obtained by said process, and an apparatus for performing said method which solve one or more of the above problems and drawbacks of the prior art, providing reliable results, without jeopardizing functionality and advantages.

### SUMMARY OF THE INVENTION

The present invention relates to a method for processing various types of natural or synthetic leather by using super-critical or near-super critical CO₂. The natural leather can be dried leather, low grade leathers, thin leather, crust leathers, finished leathers, wet blue leathers, and tanned leather. The synthetic leather can be of polymer type, such as of poly urethane (PU) or polyvinyl chloride (PVC). It is noted that super critical CO₂ may be used for treating materials with relatively open structures, such as textile, which may be dyed in a dyeing chamber using supercritical CO₂ that is previously saturated with dyestuff and that in view of the open structure can percolate through the textile tissue to allow the dye impregnation into the tissue fibres. Such an approach is not applicable for leather due to the lack of porosity thereof, inherent to the substrate structure. In addition it is noted that sc-CO₂ textile dyeing is a process mainly applied for synthetic materials and not yet to natural fibres. The present invention deals with a scCO₂-process which is applied to a natural (collagen based material) or synthetic substate being coated or uncoated and provides a solution to the above-mentioned problems and drawbacks. In the description a pressure typically relates to a working pressure of the CO₂.

Over the years, the applicant has put constant effort into the transformation of leather processing to a dry sustainable process, conducted by means of the breakthrough supercritical CO₂ technology (scCO₂). Inventors developed a process based on CO₂ techniques which is successfully proved to be used for drying, fat-liquoring and dyeing or all in “one pot process”. These processes can be conducted by high pressure CO₂ independently and seen as separate processes, too. The process steps are described below in sequence, that these steps can also be conducted independently one after the other or as a “one pot” system. The method of processing leather comprises providing to be processed leather, and processing said leather by subjecting the leather to super critical CO₂ under increased pressure of>7.3 MPa (73 bar), a temperature of >30° C., during a period of >1 minute, wherein processing comprises at least one of (a) drying leather, typically at a pressure of 8-15 MPa, such as <10 MPa, in particular at a temperature of 40-50 ° C., in particular drying pre-wetted or wet-blue leather, more in particular to a 10-14 wt. % moisture, (b) fat-liquoring leather, also referred to as softening leather, (c) dyeing tanned and dried leather, or fat-liquored leather, or finished leather, (d1) coating leather, (d2) water-proofing leather, and (d3) impregnating leather, in particular comprising (c) dyeing tanned and dried leather, or fat-liquored leather, or finished leather. The present method can be performed as independent steps, as a combination of two or more steps, and in a one-pot system. The obtained leather is of good quality, no water is used, a minimum amount of chemicals is used, the method is rather quick, and in view of consumption of materials rather cheap. The process of dyeing leather proved to be efficient and homogeneous without any wastewater. Therewith a complete process cycle including de-hydration (drying), fat-liquoring, also referred to as softening, re-tanning and dyeing, is provided.

The present invention relates to applying each of the method steps separately, to be considered as a separate independent process which runs assisted by scCO₂, or as a combined process with two or more of these method steps. The present invention provides a process to dye, impregnate, and/or colour leather efficiently, homogeneously, with high quality, good process control, and limited to no waste.

Thereby the present invention provides a solution to one or more of the above-mentioned problems and drawbacks.

### Advantages of the Present Description are Detailed Throughout the Description

Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

In a second aspect the present invention relates to leather obtained by the present method, with a tensile strength of >1 MPa. Appropriate test methods are ISO 3377-1:2011 and ISO 3377-2:2016 for determining the tear strength of leather using a double-edged tear (sometimes described as the Baumann tear test), ISO 3376: A for determining the tensile strength, elongation at a specified load and/or break of leather, ISO 3379:2015 for determination of distension and strength of surface (Ball burst method), and ISO 17235:2015 for determination of softness. Typical test results are

ISO 3376: 2020

| | Measurement on length | | Measurement on width | |
|---|---|---|---|---|
| Limit Tensile | TS | | TS | |
| strength (TS) | [MPa] | Elongation % | [MPa] | Elongation % |
| 8-15 MPa | 13.36 | 36.39 | 18.84 | 29.77 |

ISO 3377-1: 2016 Determination of tear load - Single edge tear

| Tear load min. | Length [N] | Width [N] |
|---|---|---|
| 16N | 40 | 34.9 |

ISO 3377-2: 2016 Determination of tear load - Double edge tear

| | Min. [N] based | | |
|---|---|---|---|
| Thickness [mm] | on substance | Length [N] | Width [N] |
| 1.39 | 60 | 64.7 | 65.4 |

ISO 3379: 2015 Determination of distension
and strength of surface (Ball burst method)

| Grain crack min. | [mm] until crack | Force [N] |
|---|---|---|
| 7-9 mm | 10.77 | 383.3 |

ISO 17235: 2015 Determination of softness
Nominal aperture: 25 mm
3.0

So it is found that in view of typical physical/chemical parameters of leather, the leather obtained by the present method is typically at least as good as that obtained by prior art methods, in typically better.

So it is found that in view of typical physical/chemical parameters of leather, the leather obtained by the present method is typically at least as good as that obtained by prior art methods, in typically better.

In a third aspect the resent invention relates to a stand-alone apparatus for performing a method according to the invention, comprising a quick-closure autoclave, at least one CO₂ pump, optionally a CO₂ storage, such as a bottle, or an autoclave, an integrated cooling/heating system, at least one chemical supply system, a processor and software for operating the apparatus, and a control panel for selecting at least one process step. In an example it comprises a pressurized chamber using CO₂ to P>80bar,T>34C (i.e. CO_{2>500} g/L), or P>79 bar (>400 g/L); such as near supercritical or at supercritical conditions with small amounts of water and/or solvents/modifiers (e.g. methanol, ethanol, iso-propanol, etc.) in an autoclave, where the leather is placed one on top of each other utilizing a spacer between. The spacer may be made or metal, textile or cellulose materials. The leather with the spacer can be packed into a roll consisting a number of hides. The roll fills completely the pressurized chamber. The at least one CO₂ pump provides the desired working pressures and also the optional circulation of the CO₂, preferably in an axial direction over the joint roll, during at least 20 minutes and typically up to 240 min, preferably 30 to 180min, most preferred 30 to 120 min per roll volume. Optionally a simultaneously flush of CO₂ out of the vessel and a refill with fresh/refresh CO₂ is provided, where the CO₂ from the dyeing vessel may be transferred to a second vessel where the pressure is significantly lower. Thereby residual dyestuff is removed from the CO₂. The CO₂ is refreshed and ready for renewed used after re-pressurization. It is believed that this step can be omitted, or can be quite short relative to the processing time, when the ratio of dyestuff or eventually dyestuff to the surface of leather is chosen well. The dyestuff preferably is contained in a spacer for dyeing finished leather or synthetic leather. For dyeing crust or wet blue the dyestuff is preferably deposited into a dye-holder and is up-taken by the high CO₂ flow which will help transfer the dye onto the leather. Finished leather is dyed homogeneously on the entire finished surface with low penetration into the leather using a very short process time between 10 to 30 minutes, preferably 20 minutes, and most preferred 30 min. Crust and wet blue may be dyed too. This dyeing process last longer compare to the one for the finished leather, between 1 and 5 hours, preferably between 1.5 and 4 hours, most preferably between 2 and 3 hours. This supercritical dyeing process yields dyed through leather material.

In a fourth aspect the present invention relates to a computer program comprising instructions for operating the stand-alone apparatus according to the invention, the instructions causing the computer to carry out the following steps: processing leather by subjecting the leather to super critical CO₂ under increased pressure of >7.3 MPa (73 bar), a temperature of >30° C., preferably >34° C., more preferably >40° C., during a period of >1 minute, wherein processing comprise at least one of (a) drying leather,(b) fat-liquoring leather, (c) dyeing tanned and dried leather, or fat-liquored leather, or finished leather, (d1) coating leather, (d2) waterproofing leather, and (d3) impregnating leather, in particular comprising instructions for (c) dyeing tanned and dried leather, or dyeing fat-liquored leather, or dyeing finished leather. At the end of the process, one can depressurize the pressure chamber, unroll the leather and remove the spacer between the lather to collect the ready-dyed leather in the formed of finished dyed leather, dyed crust, dyed wet blue, or dyed synthetic leather. The resulted dyed leather expose a homogeneous distribution of the dye on the leather surface as well as in depth without any stains. The process is much more efficient compared to a classical water dyeing with a result in the finished dyed leather material in less than 4 h.

The invention further pertains to a method or process comprising one or more of the characterising features described in the description and/or shown in the attached drawings. The various aspects discussed in this patent can be combined in order to provide additional advantages. Furthermore, some of the features can form the basis for one or more divisional applications.

### DETAILED DESCRIPTION OF THE INVENTION

The present invention relates in an aspect to a method according to claim 1.

In an exemplary embodiment of the present method the leather is selected from low grade leathers, thin leathers (e.g. thinner than 2 mm), crust leathers, dried leather, finished leathers, wet blue leathers, and tanned leather.

In an exemplary embodiment of the present method the method is performed in one apparatus (one-pot).

In an exemplary embodiment of the present method drying comprises subjecting the leather to super critical CO₂ under increased pressure of >0.1 MPa, preferably >7 MPa (70 bar), a temperature of >30° C., preferably >>30° C., during a period of >1 hour.

In an exemplary embodiment of the present method fat-liquoring is done by (b1) solvent exchange, or (b2) directly.

In an exemplary embodiment of the present method in case of (b1) solvent exchange the leather or wet-blue leather is (b11) pre-soaked into a solvent bath, such as during 1-24 hours, preferably during at least 2 hours, more preferably during at least 6 hours, even more preferably during at least 10 hours, such as during 12-15 hours, such as wherein the solvent can be selected among the organic solvents, miscible with CO_{2,} such as from short chain aliphatic alcohols, e.g. methanol, ethanol, propanol, and iso-propanol, from short chain ketones, like acetone, from short chain esters, like ethyl acetate, and mixtures thereof, and (b12) wherein the pre-soaked leather is then placed into an autoclave where is contacted with 10-400 gr fat-liquoring material [amount]/kg leather at high pressure of >0.1 MPa in the presence of a CO₂ flow comprising 1-10 gr fat-liquoring material/liter flow during a period of time of 10-180 minutes at a temperature of 30-90° C., such as 34-80° C. The soaking time depends on the leather thickness and the viscosity of the selected solvent used.

In an exemplary embodiment of the present method in case of direct fat-liquoring (b2) the (WB)leather is (a21) is dried to >10 wt. % moisture, such as 10-20 wt. % moisture, by subjecting the leather to direct exposure of scCO₂ in a closed autoclave removing water at a pressure of 5-50 MPa (50-500 bar) and a temperature of 30-60° C. during 10-180 minutes preferably under constant stirring and/or recirculating of scCO₂, wherein water is preferably removed over an absorbent, such over a zeolite, an ionic liquid, a water absorbing salt, a clay, a silica gel, and (b22) subsequently or concomitantly contacting the leather with an fat-liquoring material.

In an exemplary embodiment of the present method the fat-liquoring material is selected from fats and oils, such as fish oil, and sulfonated fish oil, land animals oils and fats, such as claw oil, beef tallow, pig fat, and bone fat, vegetable oils and fats, such as palm oil, sunflower oil, rapeseed oil, soybean oil, coconut fat, palm kern fat, and turkey red oil, waxes, such as carnauba wax, montane wax, and wool grease, and synthetic fats/oils, such as paraffin oil, mineral oil, fatty alcohol, fatty acid esters, and silicones.

In an exemplary embodiment of the present method (c) dyeing leather comprises
(c1) providing leather, preferably selected from fat-liquored leather, ready-made products as shoes, bags, rims, and gloves, and
(c2) contacting the leather under scCO₂ at a pressure of 5-50 MPa (50-500 bar) at a temperature of 40-120° C. during 10-180 minutes with at least one dye, wherein preferably 0.1-2 wt. % dye relative to a weight of the leather is provided.

In an exemplary embodiment of the present method the dye is selected from a dispersive dye, a reactive dispersive dye, a natural or synthetic pigment or colorant, and paints.

In an exemplary embodiment of the present method the dye is provided on a support, such as on glass beads, on porous supports, present in a dye holder, or on textile materials, preferably textiles made from natural fibers like cotton, silk, or linen, and most preferred pre-dyed (synthetic) polyester materials. It may be used as spacer for crust, finished, and synthetic leather.

In an exemplary embodiment the present method comprises providing a coating layer and/or waterproofing and/or impregnation under scCO₂ at a pressure of 5-50 MPa (50-500 bar) at a temperature of 40-120° C. during 10-180 minutes.

In an exemplary embodiment the present stand-alone apparatus may comprise a standalone high pressure machine equipped with a high pressure chamber, a CO₂ supply, a pump for bringing the CO₂ to required conditions and a CO₂ circulation system, a heating-cooling integrated system and an operation controlling cabinet provided with an easy accessible control panel. This machine can be used to dye all kinds of ready-made finished leather products or accessories like rims, wallets, shoes, bags, gloves, port-money, etc. The products can be made out of natural or synthetic leather. The dyes are brought in contact with the leather products via a support which ensures a homogeneous dye distribution on the leather products. The support can be chosen from glass beads material, dyed or impregnated textile, any other porous material which scCO₂ can penetrate through to pick up the dye. Dyes to be used in this situation can be chosen from the large scCO₂ disperse dyes variety existing on the market.

This process does not necessarily need CO₂ recirculation because the autoclave is small and the amount of CO₂ involved/usage is limited. The dyeing cycle in this machine can last between 10min to 45 min, preferred between 15min to 30 min depending on the colour intensity and amount of leather support involved. This is a machine which can be easily used for ready coloured leather products in specialized colours or shades. By utilizing different materials imprints can be created on the leather during dyeing. These imprints can create a model on the material or can be used just to personalize your leather products.(See FIGS. 7-8).

The one or more of the above examples and embodiments may be combined, falling within the scope of the invention.

### EXAMPLES

The below relates to examples, which are not limiting in nature, showing the benefits of the invention.
Drying
Drying may be achieved in two ways:
Running longer time only with CO₂:
Running with solvent (ethanol);

It is noted that in case of WB drying WB (wet blue) is considered an important step in leather processing, and the way drying is achieved is found to affect further the quality of the final product (finished leather). The resulted leather after drying advantageously still keeps the pores of the leather open, and the leather advantageously is flexible and smooth. ISO norms for leather typically will not be met if drying ends up with a crispy leather, which will be never transform into a flexible product. Once the leather is crispy and loses its flexibility, there is no way one can transform it into a product anymore. The leather cells once collapsed in a drying process with not open anymore. It is noted that drying implies removing (or extracting) water, and has nothing to do with fat removal. Drying is not inherently part of fat extraction; this is misleading because drying means one needs to remove something which is still wet to touch. The inventors typically dry free water from WB which represents approx. 50% wt. of the WB. So, starting with 10 kg WB, 5 kg thereof represents water. If this water is exchanged with ethanol then about maximum 70% (3.5 kg) is ethanol and still 1.5 kg water remains to be co-extracted with ethanol in scCO₂.

### 1. Fat-Liquoring Step (FL)

Following the current leather processing inventors start with fat-liquoring of the wet blue (WB). This process can be done in two ways:
1. A. Via solvent exchange
1. B. Directly from the original WB hide
1.A. For the solvent processing the original WB is pre-soaked into an ethanolic bath consisting at least 70% ethanol. Soaking time was of 8-18 h, preferably 15-18 h. The soaked WB is then placed into an autoclave where is contacted with fat-liquoring material at high pressure in the presence of CO₂. The fat-liquoring material used was rapeseed oil. The treated WB can contain up to 25% fat-liquor. The process consists of exposing WB to a continuous CO₂ flow enriched with fat-liquor for a period of few minutes to a couple of hours, depending of the requirements. In the current example the process duration was 1 h. The rapeseed oil was placed on filter material which was brought in direct contact with the scCO₂ flow prior to reaching the leather surface. The impregnation process ran into a closed autoclave where the conditions are brought to near supercritical point, 30-90° C. and 50-500 bar, such as 190bar. The CO₂ plays the role of the carrier for the FL simultaneously removing the soaking solvent from the WB pores by penetrating through these created leather's spaces (due to the very low surface tension values). The open pores of the leather are then rapidly/concurrently filled with the FL thus preventing the pore to collapse keeping the structure porous. The treated WB resulted from this process is smooth, has low to no VOC content and the FL imparts softness and maintained grain tightness of the leather sample.
1.B. Using wet WB without any other pre- or post- treatments
This process gives the opportunity to totally remove the need of a solvent during the process of FL and subsequently dyeing. The process allows only partially drying of the leather material to prevent the dry-bone level where the leather becomes crispy and loses its flexibility and resistance. The process is designed as such that at least 12% moisture remains in the leather and at most 14% wt. This can be attained using a cartage of moisture absorbent, which is calculated based on excess of moisture in scCO₂ at operating conditions and the total amount of leather processed. The WB is placed into the autoclave which is rapidly brought to mild, supercritical conditions where stirring or CO₂ recirculation can be applied. This process will allow the excess water to be removed by dissolving into the CO₂ and/or absorption into the desiccant. Concomitant FL is added to the system to replace partially the removed moisture from the WB. Optionally the absorbent can be placed into a lateral (CO₂ returning line) or the desiccant can be inserted like a cartridge directly into the autoclave together with the leather package. The desiccant system can be selected out of several materials (solids or liquids) like zeolites or ionic liquids (IL). The FL material can be selected from the list mentioned at point 1. A and can be brought into the autoclave via different systems (material impregnation, injection into the CO₂ line, pre-saturation of the CO₂ flow, etc.). This process takes longer than in the case 1. A, however, this step does not require any pre-treatment of the WB (pre-soaking) or any additional solvents. The fat-liquored WB resulted from this step is comparable in quality to previous ones obtained from example A and both are comparable with current fat-liquored leather obtained from a classical process.

The Crust (CS) is a term applied to tanned leathers after drying, but before dyeing. The CS can be dyed directly by contacting it directly in an autoclave with dyes used for polyester dying. These dyes are commercially available by different dye suppliers. Readymade products (like shoes, bags, rims and gloves) can be also directly dyed using the same high-pressure CO₂ technology by contacting them with a dye support. This dye support can be selected from various materials like glass beads, porous supports, or textile materials. Textiles to be considered can be made from natural fibres like cotton, silk, or linen where the dyes is well dispersed/distributed on the surface of the textile and most preferred is the pre-dyed synthetic polyester materials. Those are placed in an autoclave together with the CS and brought at elevated pressures and temperatures above the supercritical conditions of CO₂. The conditions are chosen between 80bar and 300bars most preferably between 100 and 280bar, most preferably between 120 and 250bar and a temperature between 40 and 120° C., preferably between 60 and 110° C., most preferred 80-100° C.

The finish leather (FL) is a CS which is provided with a top protective layer against wear and tear and makes it waterproof. Generally, this top layer is made of a polymer coat e.g. polyurethane. Colouring the finished leather is much faster and easier however the colour is mostly absorbed by the top polymeric coat. For finish leather the process can be optimized by using pre-coloured support material which can be introduced simultaneously in the autoclave with the leather. When reaching the optimum process conditions the dye will be equally distributed between the support material and the leather due to its solubility in scCO₂. The support material can be selected out of a polymeric material previously dyed in scCO₂. Such materials can be chosen from polyesters, polyamides, polyolefins.

Using this process, the ready-made leather goods (rims, bags, shoes, gloves, etui, etc.) can be directly dyed without pre- treatment. This gives a lot of opportunities for leather products and reduces the stock based on colours. Consumers can choose directly the colour they prefer for a complete collection of leather goods. This process may be done on spot in some shops by utilizing a small shop machine which can be set to be used only for one colour at a time and the colour selection can be made based on a coloured textile support available (a kind of colour catalogue). An example of such a machine can be seen below.

### Dyes

The dyes used for this project were provided by Colourtex Ltd and are generally dyes selected form the Corangar PE series. Other similar dyes from other suppliers can be also used.

The ratio dye/leather is calculated depending on the solubility of each dye in scCO₂, and the desired colour intensity. Normally the amount of dyes used for the process varies between 0.01 to 5% wt based on the leather mass. Preferred ratios between 0.1 and 2% wt. The recirculation flows in the process have to be kept high to allow a good uniform impregnation and penetration of the dye in the leather material or product. Re-tanning normally is done with vegetable tanning materials like mimosa, quebracho, tree tanning, etc. This is a process to fill the armpit area in the full hide. The process can be done by selecting the tanning materials which present a high solubility in scCO₂.

### Natural Colourants

The invention consists amongst others of drying and impregnation of leather with natural colourants by the means of supercritical carbon dioxide. These colourants can originate from natural sources such as red rose, black carrot, red radish, beetroot, marigold, tomato, algae, etc. In terms of chemical structure, the pigments could be flavonoids (retrieve from fruits, bark, roots, vegetables, flowers, stems, tea wine, etc.), isoprenoids (precisely carotenoids), proteins (precisely chromoproteins) and porphyrins (precisely chlorophylls), tyrosine-derived pigments (e.g. betalains, betaxanthin). Betalains are water-soluble nitrogen-containing vacuolar pigments, consisting of the red to red-violet betacyanins and the yellow-orange betaxanthins. The pigments have been supplied either by Feyecon or external suppliers.

The type of leather for this process could be wet blue, wet white (or their variation depending on the leather producer), vegetable-tanned leathers and synthetic-tanned leathers. This new method starts with a soaking part and the first part of the impregnation in which the wet blue pieces are soaked in a solution, emulsion or dispersion of pigments, alcohol and/or water. The soaking takes between 1 h and 48 h, preferably between 5 h and 24 h, more preferably between 8 h and 15 h. The pigment concentration of the soaking solution varies between 1% and 50%, preferably between 1% and 30%, more preferably between 5% and 25% on wet blue weight. After soaking, the leather pieces are put into a high-pressure vessel where the drying and the second part of the impregnation take place simultaneously with the help of supercritical carbon dioxide. The process parameters are chosen according to drying with supercritical carbon dioxide. The pressure is chosen between 0.1 MPa and 30 MPa, preferably between 7.38 MPa and 30 MPa, more preferably between 15 MPa and 30 MPa. The temperature is set between 31° C. and 100° C., preferably between 40° C. and 70° C., more preferably between 40° C. and 60° C. The cross-section of the leather is dyed through after the process. The leather feels soft and flexible, too. The hue of the colour depends on the concentration and pH of soaking solution, furthermore on the soaking time.

The invention is further detailed by the accompanying figures, which are exemplary and explanatory of nature and are not limiting the scope of the invention.

The invention is further detailed by the accompanying figures, which are exemplary and explanatory of nature and are not limiting the scope of the invention. To the person skilled in the art, it may be clear that many variants, being obvious or not, may be conceivable falling within the scope of protection, defined by the present claims.

### FIGURES

The invention although described in detailed explanatory context may be best understood in conjunction with the accompanying figures.

FIG. 1 shows a schematic overview of the process of obtaining leather.

FIG. 2a,b shows an example of a fat-liquored leather sample (to the left grain side, to the right flesh side of the leather).

FIG. 3a,b shows an example of a fat-liquored leather sample (to the left grain side, to the right flesh side of the leather.

FIG. 4a,b shows an example of dyed CS sample (to the left grain side, to the right flesh side of the leather).

FIG. 5a,b shows an example of dyed finished leather sample (to the left grain side, to the right flesh side of the leather).

FIGS. 6a and b show schematic layouts of the present stand-alone apparatus.

FIGS. 7 and 8 show treated leather.

FIG. 9 shows leather samples coloured with natural colorants.

### DETAILED DESCRIPTION OF THE FIGS.

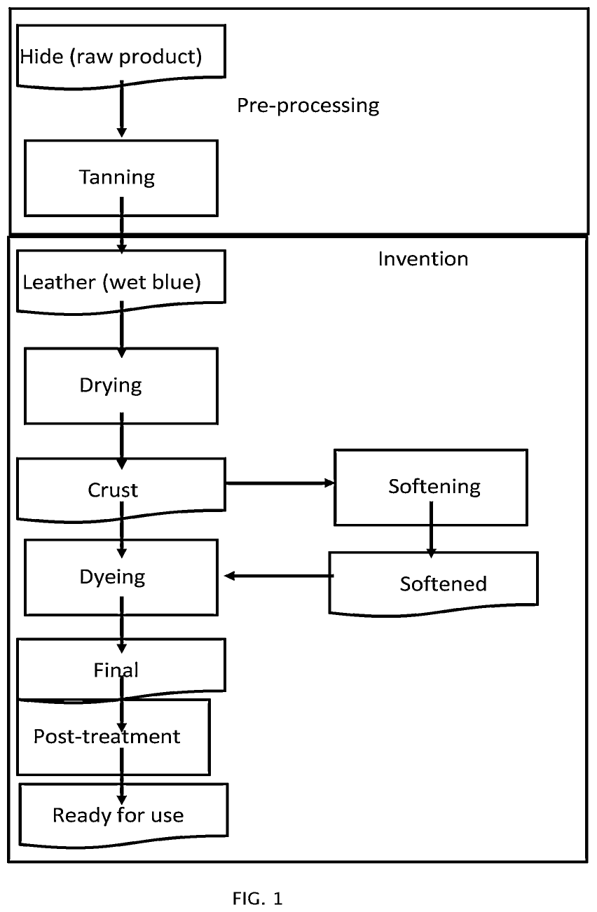

In FIG. 1 schematics of leather processing are shown. First the raw product, typically a hide or skin, is pre-processed, amongst others by removing hair. This process is called tanning and does not form part of the present invention.

The tanned leather, also referred to as wet blue, can then be further processed by drying, forming crust leather, by softening, such as by fat-liquoring, by direct dyeing of the crust or by dyeing of the softened leather, forming a ready to use leather, which may be post-processed, such as by impregnating, coating, and waterproofing.

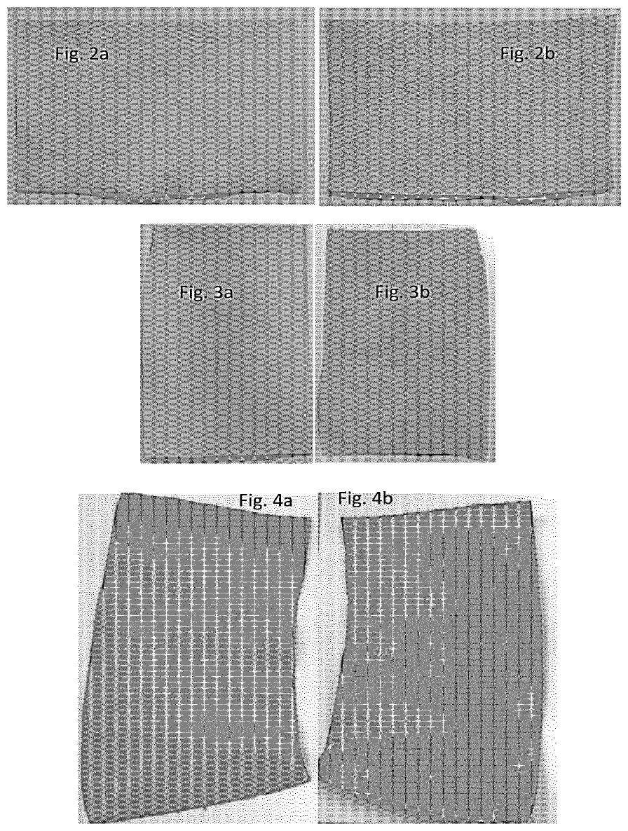

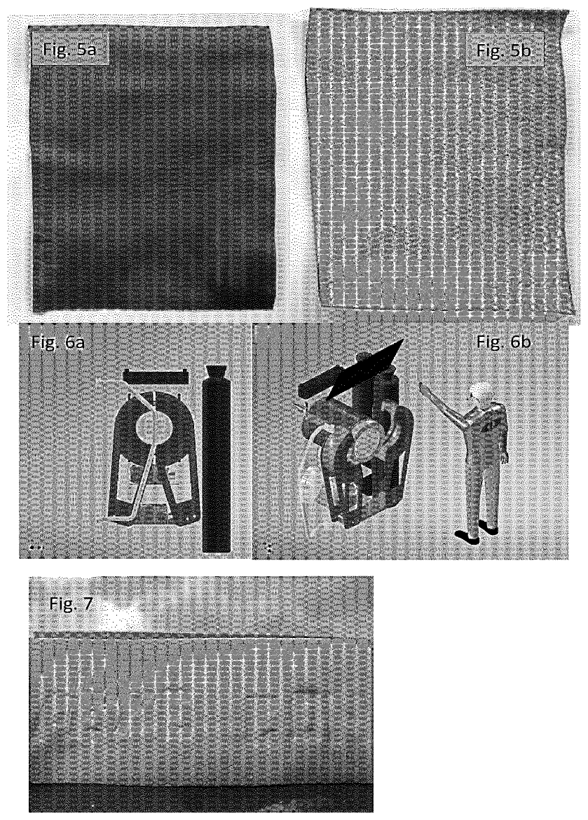

FIGS. 2-5a-b show examples of processes leather in various stages of the process.

FIGS. 6a,b shows an exemplary embodiment of the present apparatus.

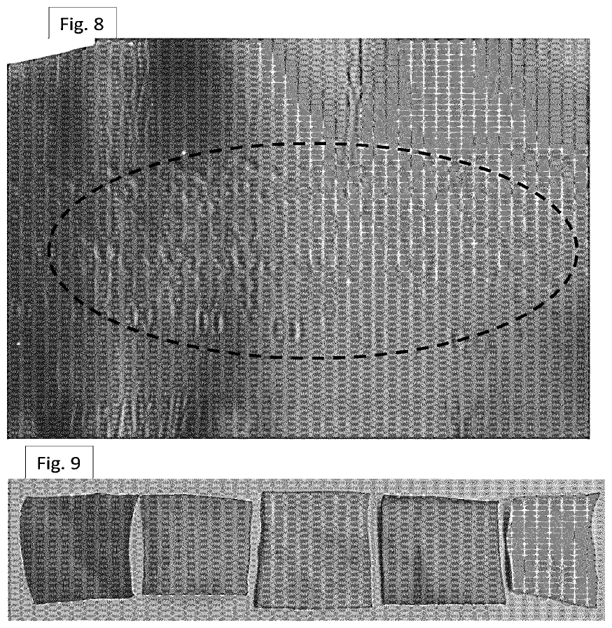

FIG. 7 shows a print of text, whereas FIG. 8 shows an imprint of “flower-like” figures, such as within the oval.

FIG. 9 shows leather samples coloured with natural colorants. Colours from left to right are red radish, black carrot, lycopene, red rose, and phycocyanin.

### Example 1. WB Soaked

Inventors used supercritical CO₂ as drying media and soaked WB in it. The hide was placed in ethanol bath for 12 h. The soaked WB was hanged inside the autoclave. On the CO₂ line a support, made of textile fibres and soaked in FL, was placed. As fat-liquor, rapeseed's cold pressed oil was used. The amount of oil used for this test was calculated as 10% wt of the soaked leather's weight. The autoclave was provided with a recirculation system.

### Example 2. WB Fat-Liquored Without Soaking

Supercritical CO₂ was used as drying media and non-treated WB was fat-liquored with it. The WB was placed into the autoclave. On the CO₂ line a support, made of textile fibres and soaked in FL, was placed. As fat-liquor, rapeseed's cold pressed oil was used. The amount of oil used for this test was calculated as 10% wt of the soaked leather's weight. The autoclave was provided with a recirculation system.

### Example 3.Crust and Dyes

Supercritical CO₂ was used as dyeing media and CS was dyed with it. The CS was hanged inside the autoclave. On the CO₂ line glass beads were placed, which were covered with dye. The amount of dye, which was used for this test, was calculated as 1% wt. of the leather's weight. The autoclave was provided with CO₂ recirculation. The collected dry dyes can be further stored for later use or re-dispersed into a mixture of matrix materials used for coating or impregnation.

### Example 4. Finished Leather

Supercritical CO₂ was used as dyeing media and finished leather was dyed with it. The finished leather was hanged inside the autoclave. On the CO₂ line glass beads were placed, which were covered with dye. The amount of dye, which was used for this test, was calculated as 1% wt. of the leather's weight. The autoclave was provided with CO₂ recirculation. The collected dry dyes can be further stored for later use or re-dispersed into a mixture of matrix materials used for coating or impregnation.

1. A method of processing leather, comprising
providing to be processed leather,
and processing said leather by subjecting the leather to super critical CO₂ (scCO₂) under increased pressure of >7.3 MPa , a temperature of >30° C., during a period of >1 minute, wherein processing comprises at least one of (a) drying leather, wherein the leather is selected from wet-blue leather, (c) dyeing tanned and dried leather, of dyeing fat-liquored leather, of dyeing finished leather, (d1) coating leather, and (d2) waterproofing leather.

2. The method according to claim 1, wherein the leather is selected from low grade leathers, thin leathers, crust leathers, dried leather, finished leathers, wet blue leathers, and tanned leather.

3. The method according to claim 1, wherein the method is performed in one apparatus.

4. The method according to claim 1, wherein drying comprises subjecting the leather to super critical CO₂ under increased pressure of >7.3 MPa, a temperature of >30° C., during a period of >1 hour.

5. The method according to claim 1, wherein fat-liquoring is selected from (b1) solvent exchange, and (b2) directly, wherein in case of (b1) solvent exchange the wet blue leather is (b11) pre-soaked into a solvent bath, during 1-24 hours, wherein the solvent is selected among the organic solvents, miscible with CO₂, at a T of >40° C. and at a pressure of >7.3 MPa, and (b12) wherein the pre-soaked leather is then placed into an autoclave where it is contacted with an amount of 10-400 gr fat-liquoring material/kg leather at high pressure of >0.1 MPa in the presence of a CO₂ flow comprising 1-10 gr fat-liquoring material/liter flow during a period of time of 10-180 minutes at a temperature of 30-90° C.,
wherein in case of direct fat-liquoring (b2) the (WB)leather is (a21) is dried to >10 wt. % moisture by subjecting the leather to scCO₂ removing water at a working pressure of 8-50 MPa and a temperature of 30-60° C. during 10-180 minutes under constant stirring and/or recirculating of scCO₂, wherein water is removed over an absorbent, selected from a zeolite, an ionic liquid, a water absorbing salt, a clay, a silica gel, and (b22) subsequently.

6. The method according to claim 5, wherein the fat-liquoring material is selected from fats and oils, land animals oils and fats, vegetable oils and fats, waxes, synthetic fats/oils, and silicones.

7. The method according to claim 1, wherein
(c) dyeing leather comprises
(c1) providing leather, and
(c2) contacting the leather under scCO₂ at a pressure of 5-500 MPa (50-500 bar) at a temperature of 40-120° C. during 10-180 minutes with at least one dye.

8. The method according to claim 7, wherein the dye is selected from a polyester dye, a pigment, colorant, and paints.

9. The method according to claim 8, wherein the natural pigment is obtained by the means of supercritical carbon dioxide, in particular wherein the natural pigment is obtained from a natural source, more in particular from red rose, black carrot, red radish, beetroot, marigold, tomato, and algae, and
wherein the natural pigment is one of a flavonoid, an isoprenoid, a protein, a porphyrin, a tyrosine-thereof. thereof.

10. The method according to claim 7, wherein the dye is provided on one of a support, glass beads, porous supports, and textile materials.

11. The method according to claim 1, comprising providing a coating layer and waterproofing and impregnation under scCO₂ at a pressure of 5-50 MPa (50-500 bar) at a temperature of 40-120° C. during 10-180 minutes.

12. A leather obtained by the method according to claim 1, with a tensile strength of >1 MPa.

13. A stand-alone apparatus for performing the method according to any claim 1, comprising
a quick-closure autoclave,
at least one CO₂ pump,
a CO₂ storage,
an integrated cooling/heating system,
at least one chemical supply system, wherein the chemical supply system comprises at least one dye, wherein the dye is selected from a polyester dye, pigment, and paints,
a processor and software for operating the apparatus, and
a control panel for selecting at least one process step.

14. A computer program comprising instructions for operating the stand-alone apparatus according to claim 13, the instructions causing the computer to carry out the following steps:
processing leather by subjecting the leather to super critical CO₂ under increased pressure of >7.3 MPa, a temperature of >30° C., during a period of >1 minute, wherein processing comprises (a) drying wet-blue leather,(c) dyeing tanned and dried leather, dying fat-liquored leather, dying-finished leather, (d1) coating leather, and (d2) waterproofing leather.
